(19) United States
(12) Patent Application Publication
(10) Pub. No.: US 2012/0280433 A1
(43) Pub. Date: Nov. 8, 2012

(54) METHOD FOR MANUFACTURING PLANT FIBER FOAM MATERIAL

(75) Inventors: Hsien-Cheng Liu, Kaohsiung Hsien (TW); Sen-Fang Hsieh, Hsinchu Hsien (TW)

(73) Assignee: TRI CAN CO., LTD., Hsin Chu Hsien (TW)

(21) Appl. No.: 13/098,637

(22) Filed: May 2, 2011

(51) Int. Cl. B29C 67/20; B29C 44/12

(52) U.S. Cl. 264/419; 264/45.3

(57) ABSTRACT

A method for manufacturing a foam material containing natural plant fibers includes: providing a plurality of plant fibers, a foaming agent, a thickening agent, a filler, and a flame retardant in a mixing tank for mixing and stirring, so as to form a homogeneous mixture; filling or injecting the homogeneous mixture into a forming container or a forming mold; utilizing a pressurizing device for applying a predetermined pressure; and heating the homogeneous mixture to a temperature higher than the foaming temperature of the foaming agent, such that foaming of the foaming agent takes place, and consequently a large amount of gas is generated, the homogeneous mixture being transformed to a plant fiber foam material having a porous foam structure. The manufacturing method can be easily carried out through existing equipments, and the plant fiber foam material is made from the natural plant fibers capable of being decomposed naturally.

### BACKGROUND OF THE INVENTION

1. Field of the Invention

The present invention relates to a method for manufacturing a foam material, and more particularly to a method for manufacturing a foam material containing natural plant fibers capable of being decomposed naturally.

2. The Prior Arts

The foam material has the advantages of lightweight, fireproof and anti-collision, and thereby it has been widely used in various fields such as in packing, filling, container, or housing of machine field. Generally, a foam material is made of a matrix material and a foaming agent, and especially, a large amount of gas is produced from the foaming agent by heating the foam material, and meanwhile the matrix material is softened or melted during heating to form a desired shape, e.g. a plate, corrugated plate, opened bottle or sealed shape. The conventional matrix material includes several artificial materials, such as thermoplastic, thermosetting plastic or rubber. Moreover, this is very easy to be accomplished by the existing processes such as injecting formation, extruding formation, rolling formation, or spraying formation in conjunction with heating process through high-temperature and high-pressure vapor, high frequency wave, ultrasonic wave, or infrared ray.

However, the disadvantages of the prior art are that the specific foaming techniques and mechanical equipments have to be provided for different foaming materials. Moreover, the cost of the matrix material is high and the matrix material itself is not easy to be decomposed. Thus, after being used, a large amount of wastes are produced, which can not be easily disposed, and thereby the serious environmental issues are generated from these wastes.

Therefore, there is a need to provide a method for manufacturing a foam material containing natural plant fibers capable of being decomposed naturally within a relatively short period of time in order to overcome the problems described above.

### SUMMARY OF THE INVENTION

The primary objective of the present invention is to provide a method for manufacturing a plant fiber foam material, which comprises: a mixing treatment: providing a plurality of plant fibers, a foaming agent, a thickening agent, a filler, and a flame retardant in a mixing tank for mixing and stirring, so as to form a homogeneous mixture, the foaming agent having a foaming temperature; an injecting treatment: filling or injecting the homogeneous mixture into a forming container or a forming mold; a pressurizing treatment: utilizing a pressurizing device for applying a predetermined pressure; and a heating treatment: utilizing a heating device, heating the homogeneous mixture to a temperature higher than the foaming temperature of the foaming agent, such that foaming of the foaming agent takes place, and consequently a large amount of gas is generated, the homogeneous mixture being transformed to a plant fiber foam material having a porous foam structure.

The plant fibers are fiber particulate composite (FPC), or selected from at least one of stalks, leaves, shells, peels and roots of natural plants, and the plant fibers come from at least one of rice straws, rice husks, malt straws, corn leaves, sugar cane leaves, flax leaves, bamboo leaves, sugar beets, forage, coconut shells, pineapple peels, and burdocks. The foaming agent includes ethylene vinyl acetate (EVA), expandable polyethylene (EPE) or polylactic acid (PLA). The filler at least includes stone powder. The thickening agent at least includes starch for increasing the viscosity. The flame retardant at least includes calcium carbonate for retarding or reducing the combustion rate. In the present invention, the plant fibers required in the plant fiber foam material can be naturally decomposed, and can be easily obtained, such as the agriculture waste produced from an agriculture product processing, and thereby the environmental protection is improved and the amount of agriculture waste can be reduced.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a flow chart showing the method for manufacturing the plant fiber foam material according to the present invention; and

FIG. 2 is a flow chart showing the method for manufacturing the plant fiber foam material according to another embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

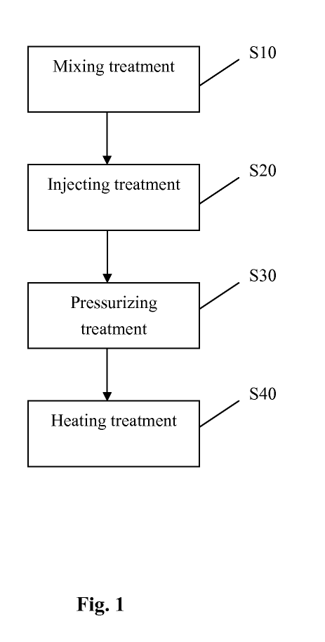

Referring to FIG. 1, which is a flow chart of the method for manufacturing plant fiber foam material according to the present invention. As shown in FIG. 1, the manufacturing method provided by the present invention includes a mixing treatment (S10), an injecting treatment (S20), a pressurizing treatment (S30) and a heating treatment (S40) in sequence in order to manufacture a plant fiber foam material with a specific shape.

Firstly, in the mixing treatment (S10), the plant fibers, the foaming agent, the thickening agent, the filler, and the flame retardant are added to a mixing tank followed by mixing under stirring for at least three hours, and a homogeneous viscous mixture is obtained, wherein the amount of the plant fibers is in the range of from 10% to 90% by weight based on the total weight of the plant fiber foam material. The plant fibers can be fiber particulate composite (FPC), or selected from at least one of stalks, leaves, shells, peels and roots of natural plants. For example, the plant fibers can be rice straws, rice husks, malt straws, corn leaves, sugar cane leaves, flax leaves, bamboo leaves, sugar beets, forage, coconut shells, pineapple peels and burdocks.

The foaming agent can be ethylene vinyl acetate (EVA), expandable polyethylene (EPE) or polylactic acid (PLA). The foaming agent has a foaming temperature at for example, 200° C., and when the temperature reached to for example 220° C. which is higher than the foaming temperature, a large amount of chemically inert gas (e.g. carbon dioxide) can be generated, by which a lot of open or closed pores are produced on the matrix material.

The filler includes, for example, stone powder, and the thickening agent includes, for example, starch for increasing the viscosity and improving the workability. The flame retardant includes, for example, calcium carbonate for retarding or reducing the combustion rate so as to improve the fireproof effect. Moreover, the flame retardant can also include epoxy adhesive and the activated carbon flame retardant, wherein the activated carbon flame retardant is a flame retardant with the activated carbon, and thereby when a fire occurs, the flame can be retarded by the flame retardant, and also the heavy smoke produced during the fire can be absorbed by the activated carbon. The activated carbon flame retardant is the most environmental friendly and safest flame retardant known in the world. Generally, the activated carbon flame retardant is made by specific treating the natural mineral which has a natural content of carbon. The activated carbon flame retardant is in the stable and non-deformed state at the temperature of 25° C. to 200° C. When the activated carbon flame retardant is heated over 200° C., the thickness thereof would expand several times or even hundreds of times, and would be transformed into vermiform powder with bulky volume so as to form an insulating carbon layer over the combusted surface of the material, and thus heat is insulated and the air flow is also reduced, and thereby the fireproof effect of the material is achieved.

Subsequently, the injecting treatment (S20) is processed. By filling or injecting process, the homogeneous viscous mixture is filled or injected into the forming container or the forming mold with a specific shape. Then the pressurizing treatment (S30) is processed for increasing the densification of the foam material. For example, a pressurizing device is utilized for applying pressure, and the pressurizing device can be a hydraulic machinery or high pressure air pump.

Finally, the heating treatment (S40) is processed. The homogeneous mixture inside the forming container or the forming mold is heated to a temperature higher than the foaming temperature (for example, 220° C.) of the foaming agent, and remaining such a temperature (for example, 220° C.) for 10 to 60 seconds, so that the foaming of the foaming agent takes place, and the homogeneous mixture is transformed to a plant fiber foam material having the porous foam structure. The heating treatment can be carried out by using high-temperature and high-pressure vapor, high frequency wave, ultrasonic wave, or infrared ray.

The manufactured plant fiber foam material can have a specific shape which depends on the shape of the forming mold, and the commercial products can be directly packed with the plant fiber foam material manufactured by the present invention so that the packed commercial products have the properties of moisture-resistance, fireproof and anti-collision.

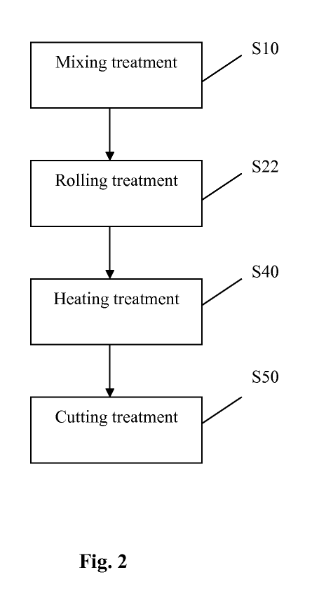

Please refer to FIG. 2, which is a flow chart showing the method for manufacturing the plant fiber foam material according to another embodiment of the present invention. The method for manufacturing the plant fiber foam material according to another embodiment of the present invention sequentially includes a mixing treatment (S10), a rolling treatment (S22), a heating treatment (S40), and a cutting treatment (S50). The plant fiber foam material obtained according to another embodiment of the present invention is in a plate-shape. The same mixing treatment (S10) and the same heating treatment (S40) as in the previous embodiment are used, and thereby there is no need to further illustrate the mixing treatment (S10) and the heating treatment (S40) here.

In the rolling treatment (S22), a rolling device is used to roll the homogeneous viscous mixture to form a preformed plate with a predetermined thickness, then the heating treatment (S40) is processed so that the foaming of the foaming agent takes place, and by which the preformed plate is transformed to a plant fiber foam material having the plate shape. Moreover, the heating treatment (S40) and the pressurizing treatment can be carried out at the same time. A thermal pressing machine can be used for carrying out the pressurizing and heating treatment in order to increase the densification of the plant fiber foam material.

Finally, the cutting treatment (S50) is processed. A cutting device is utilized to cut the plant fiber foam material to a desired size and shape.

In the present invention, the foaming process can be carried out by the existing machineries without needing to replace or install an entire new system, so that the foaming process can be applied to the various kinds of plant fiber foam materials, and the material to be used can be chosen for allowing the production cost to be minimized according to the actual needs. Especially, the required materials and the foaming agent can be customized, so that the whole production process is simplified, and the formation is easily carried out.

In the present invention, the plant fibers required in the plant fiber foam material can be naturally decomposed, and can be easily obtained, such as an agriculture waste produced from an agriculture product processing, and thereby the environmental protection is improved and the amount of agriculture waste can be reduced.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A method for manufacturing a plant fiber foam material, comprising:
a mixing treatment: providing a plurality of plant fibers, a foaming agent, a thickening agent, a filler, and a flame retardant in a mixing tank for mixing and stirring, so as to form a homogeneous mixture, the foaming agent having a foaming temperature;
an injecting treatment: filling or injecting the homogeneous mixture into a forming container or a forming mold;
a pressurizing treatment: utilizing a pressurizing device for applying a predetermined pressure; and
a heating treatment: utilizing a heating device, heating the homogeneous mixture to a temperature higher than the foaming temperature of the foaming agent, such that foaming of the foaming agent takes place, and consequently a large amount of gas is generated, the homogeneous mixture being transformed to a plant fiber foam material having a porous foam structure.

2. A method for manufacturing a plant fiber foam material, comprising:
a mixing treatment: providing a plurality of plant fibers, a foaming agent, a thickening agent, a filler, and a flame retardant in a mixing tank for mixing and stirring, so as to form a homogeneous mixture, the foaming agent having a foaming temperature;
a rolling treatment: utilizing a rolling device for rolling the homogeneous mixture to a preformed plate with a predetermined thickness;
a heating treatment: utilizing a heating device, heating the preformed plate to a temperature higher than the foaming temperature, such that foaming of the foaming agent takes place, and consequently a large amount of gas is generated, the preformed plate is transformed to a plate-shaped plant fiber foam material having a porous foam structure; and
a cutting treatment: utilizing a cutting device, cutting the plant fiber foam material to a size and a shape.

3. The method as claimed in claim 2, wherein the heating treatment and a pressurizing treatment are carried out at the same time so as to process a pressurizing and heating treatment.

4. The method as claimed in claim 1, wherein an amount of the plant fibers is 10%˜90% in weight, and the plant fibers are fiber particulate composite (FPC), or selected from at least one of stalks, leaves, shells, peels and roots of natural plants, and the plant fibers come from at least one of rice straws, rice husks, malt straws, corn leaves, sugar cane leaves, flax leaves, bamboo leaves, sugar beets, forage, coconut shells, pineapple peels, and burdocks.

5. The method as claimed in claim 1, wherein the foaming agent includes ethylene vinyl acetate (EVA), expandable polyethylene (EPE) or polylactic acid (PLA), and the filler at least include stone powder, and the thickening agent at least include starch for increasing the viscosity, and the flame retardant at least includes calcium carbonate for retarding or reducing the combustion rate.

6. The method as claimed in claim 1, wherein the heating treatment is carried out by using high-temperature and high-pressure vapor, high frequency wave, ultrasonic wave, or infrared ray.
